(19) United States
(12) Patent Application Publication
(10) Pub. No.: US 2007/0179708 A1
(43) Pub. Date: Aug. 2, 2007

(54) Method And Apparatus For Creating Map Data And Method And Apparatus For Route Search

(76) Inventors: Minoru Sekine, Tokyo (JP); Masaaki Ohira, Iwaki-city (JP)

Correspondence Address: BRINKS HOFER GILSON & LIONE, P.O. BOX 10395, CHICAGO, IL, 60610, US

(21) Appl. No.: 11/668,289

(22) Filed: Jan. 29, 2007

(30) Foreign Application Priority Data
Jan. 30, 2006 (JP) 2006-020436

(51) Int. Cl. G01C 21/32

(52) U.S. Cl. 701/208; 701/209; 340/995.1

(57) ABSTRACT

A method for creating map data for navigation includes setting a plurality of levels corresponding to levels of detail, stratifying meshes at the individual levels, and creating map data that includes road information of the individual meshes at the individual levels. The map data includes, for individual combinations of two meshes at a predetermined level, data for identifying meshes at the predetermined level that are used to search for routes from one mesh in each of the combinations of two meshes to the other mesh in each of the combinations of two meshes as search range data.

### RELATED APPLICATIONS

The present application claims priority to Japanese Patent Application Number 2006-020436, filed Jan. 30, 2006, the entirety of which is hereby incorporated by reference.

### BACKGROUND OF THE INVENTION

1. Field of the Invention

The present invention relates to methods and apparatuses for creating map data and methods and apparatuses for conducting a route search, and in particular, relates to a method for creating map data and a method for conducting a route search for navigation, and apparatuses that realize these methods, in which a plurality of levels corresponding to levels of detail are set, meshes at the individual levels are stratified, and map data that includes road information of the individual meshes at the individual levels is created.

2. Description of the Related Art

A navigation apparatus reads map data corresponding to the current position of a vehicle from a medium for storing a map, such as a compact disk read only memory (CD-ROM), a digital versatile disk (DVD), or a hard disk drive (HDD), draws the map on a display screen, displays a vehicle mark at a predetermined position on the display screen, and scrolls the map in response to travel of the vehicle. The navigation apparatus further has a route guidance function of searching for a guided route from a starting location to a destination location or a guided route from a starting location to a destination location via specified intermediate points and displaying the guided route on the map. A first known technique for performing a high-speed route search is disclosed in Japanese Unexamined Patent Application Publication No. 2003-337034, in which a high-speed route search is achieved by storing exclusive networks between meshes in map data and decreasing the number of search branches using the exclusive networks. Furthermore, a second known technique is disclosed in Japanese Unexamined Patent Application Publication No. 2004-286524, in which a hierarchical search is performed using hierarchical map data, not exclusive networks.

In the first known technique, five levels corresponding to levels of detail are set, and road information of a map is constructed of road information at the individual levels and information of exclusive networks, as shown in FIG. 15A. A basic part at each level is a part for identifying information of roads that exist in areas corresponding to each level, and an extended part at each of level 1 and level 2 represents information for high-speed search. Exclusive networks store route information (information about links, nodes, and the like) necessary to search for routes that connect certain level 2 areas associated with information of the combination of two level 2 areas.

When a starting location S is determined, a level 1 area A1 that includes the starting location S and a level 2 area C1 that includes the level 1 area A1 are determined, as shown in FIG. 15B. Similarly, when a destination location E is determined, a level 1 area A2 that includes the destination location E and a level 2 area C2 that includes the level 1 area A2 are determined. Since information of an exclusive network is provided so as to correspond to the combination of the level 2 areas C1 and C2, a route search is performed using the information of the exclusive network. Specifically, higher-layer-transition nodes P11, P12, and P13 relating to the starting location S and higher-layer-transition nodes Q11, Q12, and Q13 relating to the destination location E are extracted using map information at level 1 and extended information of the exclusive network. Then, a plurality of routes between higher nodes N11, N12, and N13 corresponding to the higher-layer-transition nodes P11, P12, and P13 and higher nodes M11, M12, and M13 corresponding to the higher-layer-transition nodes Q11, Q12, and Q13 are searched for using the information of the exclusive network (information about links, nodes, and the like), and the least cost route is determined as being a guided route.

In the second known technique, road information is constructed by stratifying a map into levels 1 to 4, as shown in FIG. 16. Level 1 is a part for identifying map information of roads subject to guidance and roads (narrow streets) not subject to guidance. Level 2 is a part for identifying road information of roads subject to guidance. Level 3 is a part for identifying map information of main roads. Level 4 is a part for identifying map information of superior main roads (prefectural roads, national roads, and expressways). When a starting location S and a destination location E are determined, at level 2, a node b10 that migrates to a higher node at level 3 is determined from the starting location S, a node c10 that migrates to a higher node at level 4 is determined from the node b10, and then routes from the starting location S to the higher node c10 are determined. Similarly, routes from the destination location E to a higher node c20 at level 4, which is the highest level, are determined. Then, routes from the higher node c10 on the starting location S side to the higher node c20 on the destination location E side are searched using road information at level 4, and finally, the least cost route from the starting location S to the destination location E is searched.

In the first known technique, a problem exists in that the data size of road information is large because the number of exclusive networks is very large. Furthermore, when difference map data is created and when the map data is updated with the difference map data, the amount of difference data of exclusive networks is large. Thus, when the difference map data is obtained through a network, the time necessary to transmit the difference map data is disadvantageously long, thereby increasing the communication cost. Furthermore, the time necessary to update the map is long.

In a hierarchical search performed in the second known technique, a method exists in which the optimum route to a destination location is obtained without extending unnecessary search branches as much as possible, at the expense of heuristic cost. However, even in this case, unnecessary search branches are disadvantageously extended, so that the search time is extended. FIG. 17 shows how search branches are extended when a route from the Tokyo station to the Osaka station is searched. In FIG. 17, shaded parts represent areas where search branches are extended.

Accordingly, it is an object of the present invention to maintain the quality level of a route that is searched for and achieve a high-speed route search.

### SUMMARY OF THE INVENTION

The aforementioned problems can be solved by a method according to a first aspect of the present invention for creating map data for navigation for setting a plurality of levels corresponding to levels of detail, stratifying meshes at the individual levels, and creating map data that includes road information of the individual meshes at the individual levels. The map data includes, for individual combinations of two meshes at a predetermined level, data for identifying meshes at the predetermined level that are used to search for routes from one mesh in each of the combinations of two meshes to the other mesh in each of the combinations of two meshes as search range data.

The method according to the first aspect of the present invention for creating map data may include a step of creating a list of boundary-exit links that exit from each of the meshes and a list of boundary-entrance links that enter each of the meshes for each of the meshes with reference to the road information of each of the meshes, a step of, for individual combinations of two meshes, searching for all routes from boundary-exit links in one mesh in each of the combinations of two meshes to boundary-entrance links in the other mesh in each of the combinations of two meshes, and a step of creating the search range data from data for identifying meshes to which links that constitute each of the searched routes belong.

The method according to the first aspect of the present invention for creating map data may include a step of creating a list of boundary-exit links that exit from each of the meshes and a list of boundary-entrance links that enter each of the meshes for each of the meshes with reference to the road information of each of the meshes, a step of performing a search from boundary-exit links in a first mesh until the search cannot be performed and, after performing the search, obtaining all routes from the boundary-exit links in the first mesh to boundary-entrance links in a second mesh with reference to the search result, and a step of creating search range data corresponding to a combination of the first and second meshes by determining meshes to which links that constitute each of the searched routes belong.

The aforementioned problems can be solved by a method according to a second aspect of the present invention for route search for a navigation apparatus that searches for a route to a destination location that includes a step of setting a plurality of levels corresponding to levels of detail, stratifying meshes at the individual levels, storing, for individual combinations of two meshes at a level immediately below a top level, data for identifying meshes that are used to search for routes from one mesh in each of the combinations of two meshes to the other mesh in each of the combinations of two meshes as search range data, together with road information of the individual meshes at the individual levels, in map data, performing control so that a link that constitutes road information at the top level does not cross over meshes at the level immediately below the top level, and storing, in a link record of the link, identification data of a mesh at the level immediately below the top level where the link exists, and a step of searching for a route between nodes at the top level, using top-level links having mesh identification data of meshes that are defined to be used for route search in the search range data.

The aforementioned problems can be solved by an apparatus according to a third aspect of the present invention for creating map data for navigation for setting a plurality of levels corresponding to levels of detail, stratifying meshes at the individual levels, and creating map data that includes road information of the individual meshes at the individual levels includes a link-list creating unit that creates a list of boundary-exit links that exit from each of the meshes and a list of boundary-entrance links that enter each of the meshes for each of the meshes with reference to the road information of each of the meshes, a route searching unit that, for individual combinations of two meshes, searches for all routes from boundary-exit links in one mesh in each of the combinations of two meshes to boundary-entrance links in the other mesh in each of the combinations of two meshes, and a search-range-data creating unit that creates, from data for identifying meshes to which links that constitute each of the searched routes belong, search range data for identifying meshes that are used to search for routes from one mesh in each of the combinations of two meshes to the other mesh in each of the combinations of two meshes.

An apparatus according to a fourth aspect of the present invention for creating map data for navigation for setting a plurality of levels corresponding to levels of detail, stratifying meshes at the individual levels, and creating map data that includes road information of the individual meshes at the individual levels includes a link-list creating unit that creates a list of boundary-exit links that exit from each of the meshes and a list of boundary-entrance links that enter each of the meshes for each of the meshes with reference to the road information of each of the meshes, a route searching unit that performs a search from boundary-exit links in a first mesh until the search cannot be performed and, after performing the search, obtains all routes from the boundary-exit links in the first mesh to boundary-entrance links in a second mesh with reference to the search result, and a search-range-data creating unit that creates, from data for identifying meshes to which links that constitute each of the searched routes belong, search range data for identifying meshes that are used to search for routes from the first mesh to the second mesh.

The aforementioned problems can be solved by a navigation apparatus according to a fifth aspect of the present invention that searches for a route to a destination location and includes a map-data storage unit that stores, for individual combinations of two meshes at a level immediately below a top level, data for identifying meshes that are used to search for routes from one mesh in each of the combinations of two meshes to the other mesh in each of the combinations of two meshes as search range data, together with road information of the individual meshes at individual levels, in map data, performs control so that a link that constitutes road information at the top level does not cross over meshes at the level immediately below the top level, and stores the map data, which includes, in a link record of the link, identification data of a mesh at the level immediately below the top level where the link exists, a destination-location setting unit that sets a destination location, and a route searching unit that obtains individual nodes at the top level on a starting location side and a destination location side and searches for a route between the nodes, using links at the top level having mesh numbers of meshes that are defined to be used for route search in the search range data.

In the present invention, the map data includes, for individual combinations of two meshes at a predetermined level, data for identifying meshes at the predetermined level that are used to search for routes from one mesh in each of the combinations of two meshes to the other mesh in each of the combinations of two meshes as search range data. Thus, the search range can be narrowed down using the search range data, thereby enabling a high-speed route search.

Furthermore, in the present invention, only identification data of meshes subject to search needs to be stored as search range data. Thus, the size of the search range data and the size of difference data that is used when the map is updated can be reduced.

Furthermore, in the present invention, a search is performed from boundary-exit links in a first mesh until the search cannot be performed and, after performing the search, all routes from the boundary-exit links in the first mesh to boundary-entrance links in a second mesh are obtained with reference to the search result, and search range data corresponding to a combination of the first and second meshes is created by determining meshes to which links that constitute each of the searched routes belong. Thus, search range data can be created at a high speed.

### BRIEF DESCRIPTION OF THE DRAWINGS

FIG. 1 is an illustration of road information included in map data according to the present invention;

FIG. 2 is an illustration of search range data;

FIG. 3 is an illustration of exemplary meshes;

FIGS. 4A and 4B are illustrations of link records included in the road information;

FIG. 5 is an illustration showing that a level 4 link is formed so as not to cross over level 3 areas;

FIG. 6 is a block diagram of a map creating apparatus according to the present invention;

FIGS. 7A to 7D are illustrations showing a process of creating a map according to the present invention;

FIG. 8 is an illustration showing the outline of the Dijkstra method in a case where the cost is distance;

FIG. 9 is a flowchart of a route search process using the Dijkstra method;

FIG. 10 is a flowchart of a first process of creating search range data according to the present invention;

FIG. 11 is a flowchart of a second process of creating search range data according to the present invention;

FIG. 12 is a block diagram of a navigation apparatus according to the present invention;

FIG. 13 is a flowchart of a process of searching for a guided route according to the present invention in a case where a starting location and a destination location are input;

FIG. 14 is an illustration showing a process of determining whether a certain level 4 link is used for a route search;

FIGS. 15A and 15B are illustrations of a first known technique;

FIG. 16 is an illustration of a second known technique; and

FIG. 17 is an illustration showing a problem with the second known technique.

### DESCRIPTION OF THE PREFERRED EMBODIMENTS

### (A) Outline of the Invention

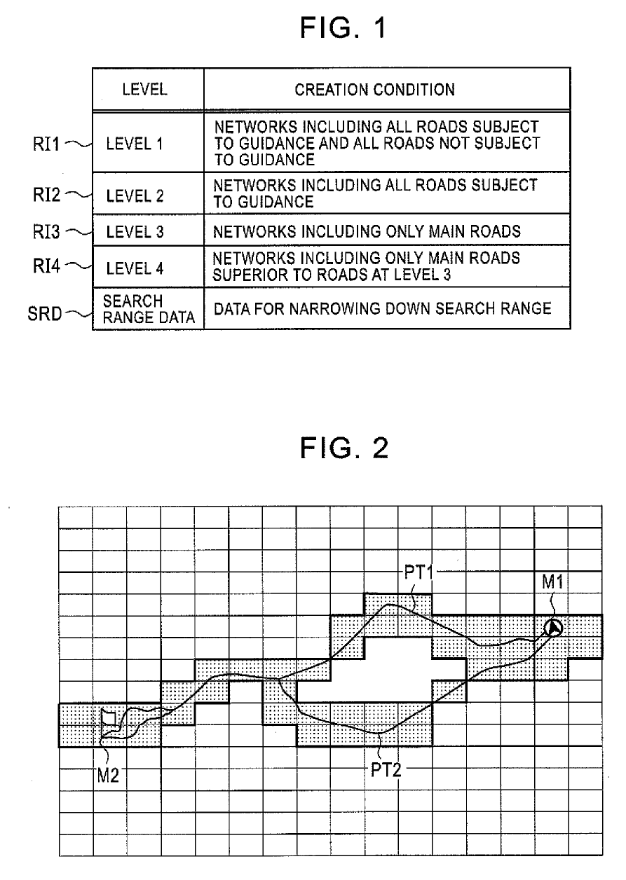

FIG. 1 is an illustration of road information included in map data according to the present invention. A plurality of levels (levels 1 to 4) corresponding to levels of detail are set, meshes at the individual levels are stratified, and road information is constructed of road information RI1 to RI4 of the individual meshes at the individual levels and search range data SRD that is used when a route search is performed.

Level 1 is a part for identifying map information of roads subject to guidance and roads not subject to guidance. Level 2 is a part for identifying road information of roads subject to guidance. Level 3 is a part for identifying map information of main roads. Level 4 is a part for identifying map information of superior main roads (prefectural roads, national roads, and expressways).

The search range data SRD in the map data includes, for the combination of two particular meshes M1 and M2 at a predetermined level (for example, level 3), data for identifying meshes (meshes within heavy lines) that are used to search for routes from one mesh M1 to the other mesh M2, as shown in FIG. 2.

The search range data SRD is created by using, for example, the following procedure: (1) A list of boundary-exit links that exit from each mesh and a list of boundary-entrance links that enter each mesh are created for each mesh with reference to road information of each mesh. (2) For each combination of two meshes, all routes PT1, PT2, . . . from individual boundary-exit links in one of the two meshes to boundary-entrance links in the other mesh are searched. (3) Data for identifying meshes, to which links that constitute each of the searched routes belong, is created as search range data corresponding to each combination of two meshes.

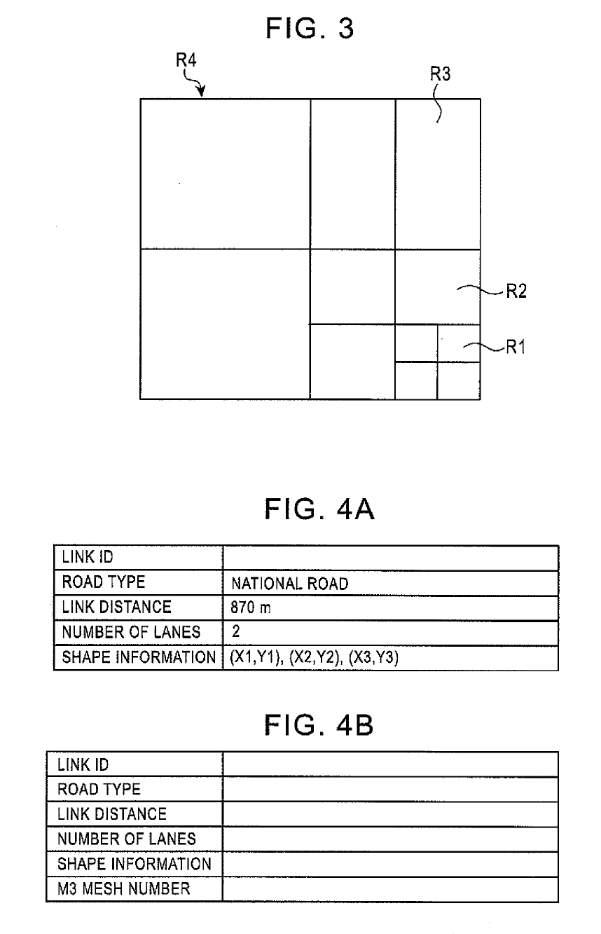

FIG. 3 is an illustration of exemplary meshes. A map is stratified into level 4 meshes, level 3 meshes, level 2 meshes, or level 1 meshes, depending on the covered area. An area R4 that is a level 4 mesh includes a plurality (four in a case shown in the drawing) of areas R3 that are level 3 meshes. Similarly, each of the areas R3 includes four areas R1 that are level 2 meshes, and each of the areas R2 includes four areas R1 that are level 1 meshes.

FIGS. 4A and 4B are illustrations of link records included in the road information. A link represents a part of a road from one intersection to another intersection. As shown in FIG. 4A, a link record includes (1) a link identification (ID), (2) a road type, (3) link distance, (4) the number of lanes, and (5) shape information (location data of a starting node, an intermediate node, and an end node) for identifying the shape of the link. Each of the link records associated with a mesh number is included in a map so that the mesh number of a mesh to which a corresponding link belongs can be identified. Each of the level 4 links is formed so as not to cross over level 3 areas, and the link record of each of the level 4 links includes a mesh number of a corresponding level 3 area, as shown in FIG. 4B.

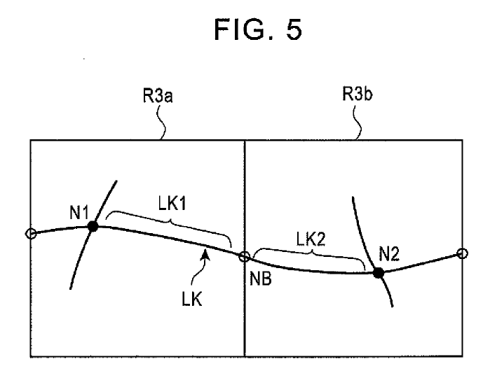

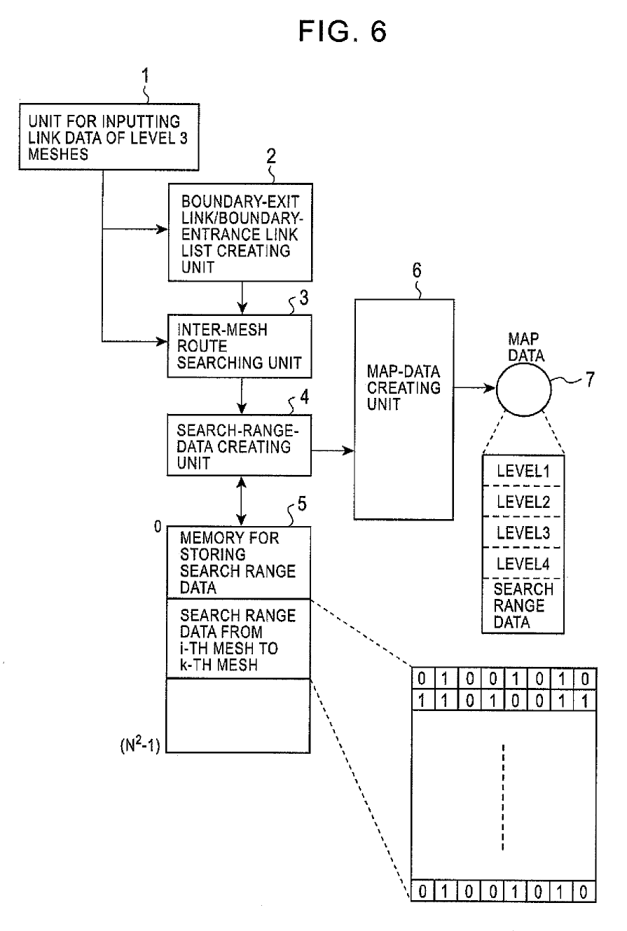

FIG. 5 is an illustration showing that a level 4 link is formed so as not to cross over level 3 areas. In FIG. 5, a link LK that includes intersections N1 and N2 as the starting point and the end point crosses over level 3 areas R3a and R3b. In this case, the link LK is divided into two level 4 links LK1 (N1-NB) and LK2 (NB-N2) at the boundary between the level 3 areas R3a and R3b, a link record is created for each of the level 4 links LK1 and LK2, and individual mesh numbers of the level 3 areas R3a and R3b are assigned to the level 4 links LK1 and LK2, respectively.

### (B) Search Data Creation

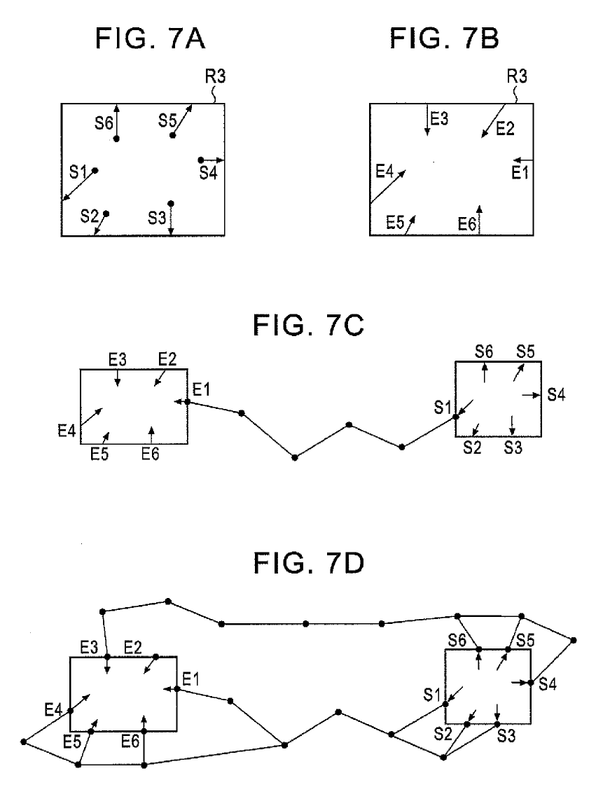

FIG. 6 is a block diagram of a main part of a map creating apparatus according to the present invention. FIGS. 7A to 7D are illustrations showing a process of creating a map according to the present invention.

A link-data input unit 1 inputs link records of level 3 meshes into a list creating unit 2 and a route searching unit 3. The list creating unit 2 creates a list of boundary-exit links that exit from all level 3 meshes and a list of boundary-entrance links that enter the level 3 meshes with reference to the link records of the level 3 meshes. FIG. 7A is an illustration of boundary-exit links. Boundary links S1 to S6 through which a user passes when the user moves from a target area R3 that is a level 3 mesh to the adjacent meshes are boundary-exit links. FIG. 7B is an illustration of boundary-entrance links. Boundary links E1 to E6 through which the user passes when the user enters the target area R3 from the adjacent meshes are boundary-entrance links.

For each combination of any two level 3 meshes, the route searching unit 3 searches for all routes from the boundary-exit links S1 to S6 in one of the two meshes to the boundary-entrance links E1 to E6 in the other mesh by a predetermined route search method, for example, the Dijkstra method. As shown in FIGS. 7C and 7D, the route searching unit 3 searches for:
all routes from the boundary-exit link S1 to the boundary-entrance links E1 to E6,
all routes from the boundary-exit link S2 to the boundary-entrance links E1 to E6,
all routes from the boundary-exit link S3 to the boundary-entrance links E1 to E6,

. . .
all routes from the boundary-exit link S6 to the boundary-entrance links E1 to E6.

A search-range-data creating unit 4 creates search range data and stores the search range data in a memory 5. The search range data includes mesh numbers of level 3 meshes to which level 3 links that constitute each of the aforementioned routes, which are searched by the route searching unit 3, belong. The combination of the corresponding two level 3 meshes is associated with the mesh numbers of the level 3 meshes. To store the search range data, K bytes corresponding to each of the combinations of two meshes are reserved in the memory 5, and, in each of the bits in the K bytes, information on whether a corresponding mesh includes one of the links, which constitute the aforementioned routes, is recorded. Specifically, the first to (8×K)-th bits in the K bytes are set so as to correspond to mesh numbers 1 to (8×K). When one of the links, which constitute the aforementioned routes, belongs to a mesh, a bit corresponding to the mesh is set to “1” In this way, the search range data is created and stored. The aforementioned process is repeated for all combinations of meshes, and the resulting search range data is stored in the memory 5.

A map-data creating unit 6 creates road layer information using road information at the individual levels and the search range data, created as described above, and records the road layer information in, for example, a DVD 7.

### (C) Route Search Method

Dijkstra Method

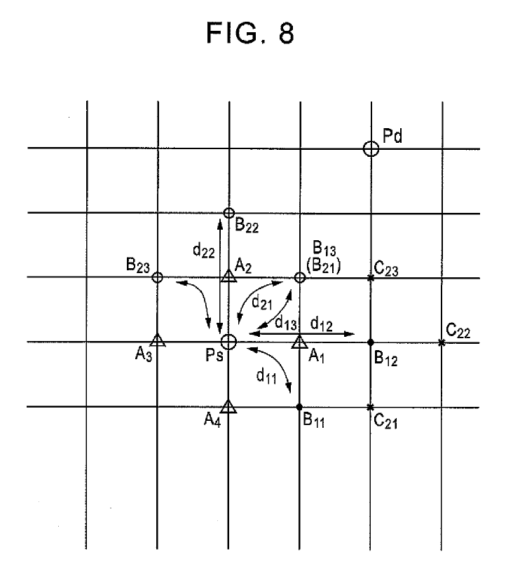

FIG. 8 is an illustration showing the outline of the Dijkstra method in a case where the cost is distance. In FIG. 8, straight lines represent roads, and intersecting points of the straight lines represent intersections. Distances between the intersections are known. Reference letters Pₛ and P_{d} denote a starting location (the vehicle location) and a destination location, respectively. In the Dijkstra method, first intersections A₁ to A₄ adjacent to the starting location Pₛ are obtained, and a zeroth intersection (the starting location) and the distance from the starting location Pₛ to each of the first intersections A₁ to A₄, associated with each of the first intersections A₁ to A₄, are stored. Then, a second intersection Bᵢⱼ is obtained for each of the first intersections A₁ to A₄, and the distance from the starting location Pₛ to the second intersection Bᵢⱼ via each of the first intersections A₁ to A₄, associated with the second intersection Bᵢⱼ, is obtained and stored. For example, three second intersections B₁₁, B₁₂, and B₁₃ are obtained for the first intersection A₁, and the following distances respectively associated with the second intersections B₁₁, B₁₂, and B₁₃ are stored: the distance d₁₁ from the starting location Pₛ to the second intersection B₁₁ via the first intersection A₁, the distance d₁₂ from the starting location Pₛ to the second intersection B₁₂ via the first intersection A₁, and the distance d₁₃ from the starting location Pₛ to the second intersection B₁₃ via the first intersection A₁. Moreover, three second intersections B₂₁, B₂₂, and B₂₃ are obtained for the first intersection A₂, and the following distances respectively associated with the second intersections B₂₁, B₂₂, and B₂₃ are stored: the distance d₂₁ from the starting location Pₛ to the second intersection B₂₁ via the first intersection A₂, the distance d₂₂ from the starting location Pₛ to the second intersection B₂₂ via the first intersection A₂, and the distance d₂₃ from the starting location Pₛ to the second intersection B₂₃ via the first intersection A₂. Similarly, second intersections are obtained for the first intersections A₃ and A₄, and predetermined items of data are stored.

In this case, the second intersections B₁₃ and B₂₁ are the same. When intersections, data of which needs to be stored, overlap one another, the distance d₁₃ and the distance d₂₁ are compared, and only the data of the smaller distance is stored. For example, when the distance d₂₁ is smaller than the distance d₁₃, the distance d₂₁ is stored as the data of the second intersection B₁₃ (=B₂₁).

Then, similarly, a third intersection Cᵢⱼ is obtained for each of the second intersections, and the distance from the starting location Pₛ to the third intersection Cᵢⱼ via each of the second intersections, associated with the third intersection Cᵢⱼ, is obtained and stored. Generally, an (i+1)-th intersection is obtained for each of the i-th intersections, and the cumulative distance from the starting location Pₛ to the (i+1)-th intersection via each of the i-th intersections, associated with the (i+1)-th intersection, is obtained and stored. Finally, the destination location P_{d} is reached. In the aforementioned description, the Dijkstra method was described on the basis of nodes. Alternatively, the Dijkstra method may be described on the basis of links.

Route Search Process Using Dijkstra Method

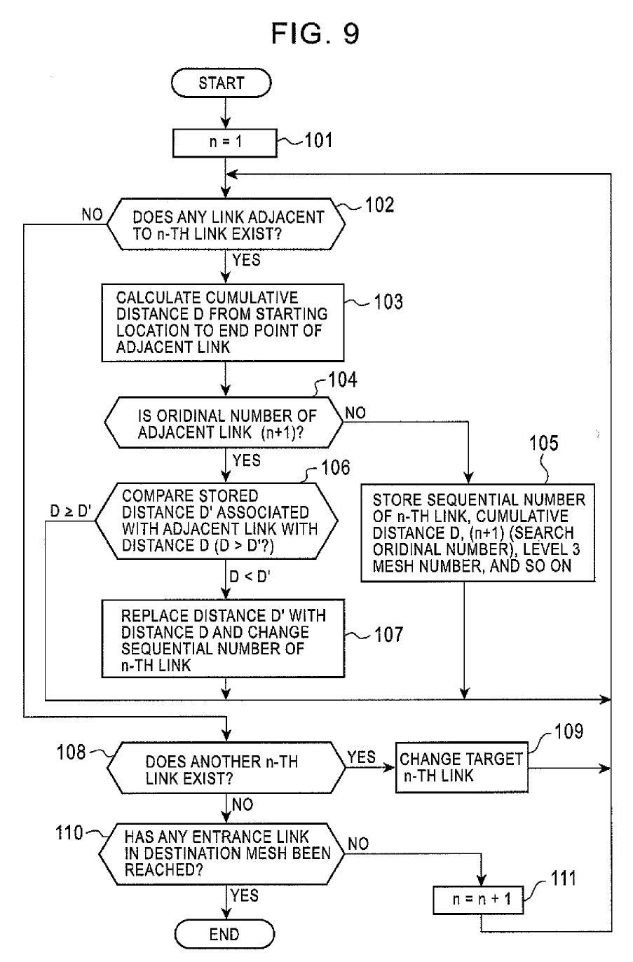

FIG. 9 is a flowchart of a route search process using the Dijkstra method in a case where the cost is distance. In this case, a mesh where a destination location exists and a mesh where a starting location exists are called a destination mesh and a starting mesh, respectively.

A j-th boundary-exit link in a predetermined starting mesh is selected, and the search ordinal number n of the j-th boundary-exit link is set to one in step 101. Then, in step 102, it is determined whether any link that connects to an n-th link Ln exists. A first link is a link that connects to the starting location P₅ when a link (called an adjacent link) that connects to the n-th link Ln exists, the process proceeds to step 103. In step 103, the cumulative distance D from the starting location Pₛ to the end point of the adjacent link Lᵢⱼ via the n-th link Ln is calculated.

The distance dₙ from the starting location Pₛ to the end point of the n-th link Ln, associated with the n-th link Ln, is stored, as described below, and the distance dₐⱼ of the adjacent link Lₐⱼ is stored in a corresponding link record. Thus, the cumulative distance D from the starting location Pₛ to the end point of the adjacent link Lₐⱼ is obtained by the following equation:

D=dₙ+dₐⱼ.

Then, in step 104, it is determined whether the search ordinal number of the adjacent link Lₐⱼ is (n+1). When the search ordinal number of the adjacent link Lₐⱼ is not (n+1), the process proceeds to step 105. In step 105, the following items of data associated with the adjacent link Lₐⱼ are stored in a storage unit:
(1) the sequential number of the current target n-th link,
(2) the cumulative distance D from the starting location Pₛ to the end point of the adjacent link Lₐⱼ,
(3) (n+1) as the search ordinal number of the adjacent link Lₐⱼ,
(4) the level 3 mesh number, and
(5) the link number of the adjacent link Lₐⱼ.

Then, the process returns to step 102 where it is determined whether another link that connects to the target n-th link Ln exists, and the subsequent process is repeated.

When it is determined in step 104 that the search ordinal number of the adjacent link Lₐⱼ is (n+1), i.e., when the adjacent link Lₐⱼ is referred to as a link adjacent to another n-th link (when the items (1) to (5) of data have been already stored in step 105), the process proceeds to step 106. In step 106, the cumulative distance D′ from the starting location Pₛ, associated with the adjacent link Lₐⱼ, which is stored, is compared with the cumulative distance D calculated in step 103. When the cumulative distance D is smaller than the cumulative distance D′, the process proceeds to step 107. In step 107, the sequential number of the n-th link, associated with the adjacent link Lₐⱼ and stored in the storage unit, is replaced with the sequential number of the current target n-th link, and the cumulative distance D′ is replaced with the cumulative distance D. Then, the process returns to step 102 where it is determined whether another link that connects to the target n-th link Ln exists, and the subsequent process is repeated. On the other hand, when the cumulative distance D is equal to or more than the cumulative distance D′, the process returns to step 102 without changing the content associated with the adjacent link Lₐⱼ and stored in the storage unit.

When it is determined in step 102 that another link that connects to the target n-th link Ln does not exist, the process proceeds to step 108. In step 108, it is determined whether another n-th link exists. When another n-th link exists, the process proceeds to step 109 where the other n-th link is set as a new target n-th link. Then, step 102 and the subsequent steps are repeated. When it is determined in step 108 that another n-th link does not exist, the process proceeds to step 110. In step 110, it is determined whether any entrance link in a destination mesh has been reached. When no entrance link in the destination mesh has been reached, the process proceeds to step 111 where the search ordinal number is incremented by one. Then, step 102 and the subsequent steps are repeated. When an entrance link in the destination mesh has been reached, the route search process is completed. In the aforementioned process, the cost is distance. However, when the cost includes factors other than distance, cost C may be used instead of distance.

When the search process is completed, the least cost (distance) route from a j-th boundary-exit link that is a first link in an i-th starting mesh to a predetermined boundary-entrance link in the destination mesh can be obtained by sequentially connecting (1) the boundary-entrance link (assumed to be an M-th link), (2) an (M−1)-th link that is associated with the boundary-entrance link and stored, (3) an (M−2)-th link that is associated with the (M−1)-th link and stored, . . . , (4) the first link (the j-th boundary-exit link in the i-th starting mesh) that is associated with a second link and stored.

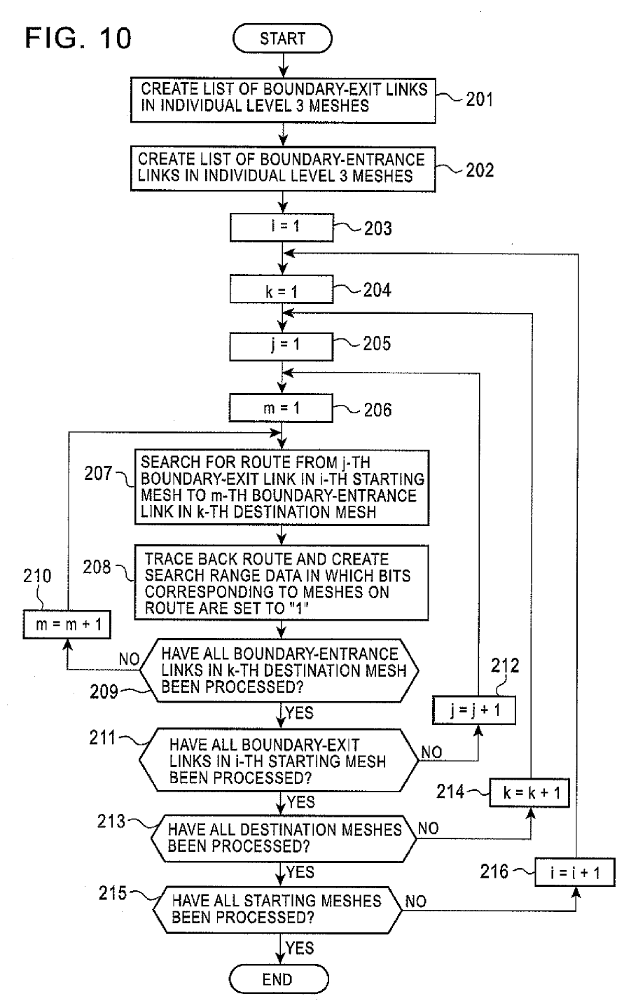

In step 208 in a flowchart of a first process of creating search range data shown in FIG. 10, which is described below, search range data is created by setting bits corresponding to level 3 mesh numbers of links that constitute the route obtained in the aforementioned process to “1”.

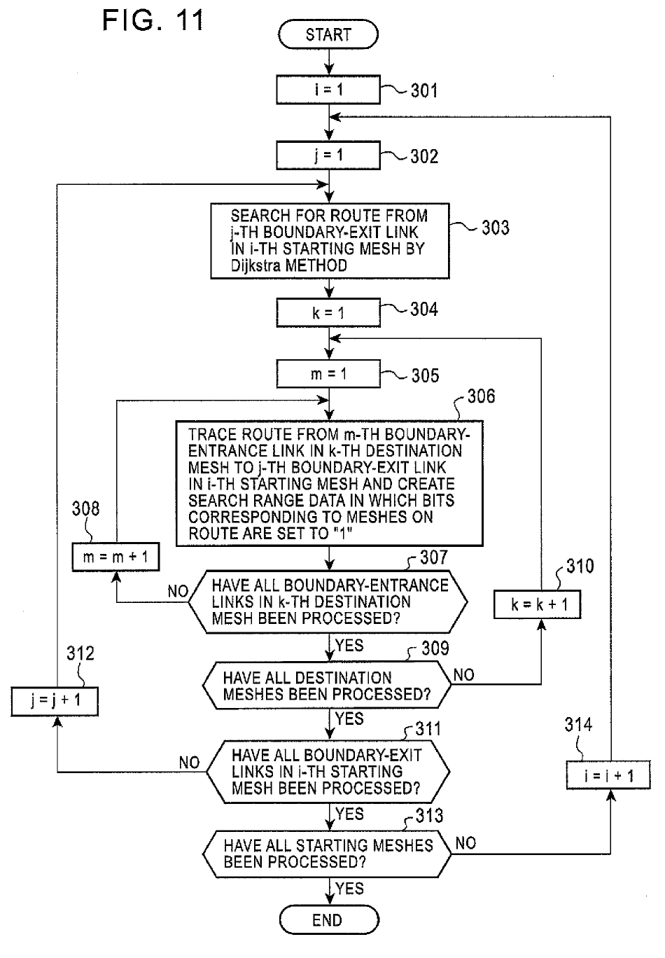

In a search process in step 303 in a flowchart of a second process of creating search range data shown in FIG. 11, in the aforementioned step 10, it is determined whether search branches can be extended. When search branches can be extended, the process proceeds to step 111 where the search ordinal number is incremented by one. Then, step 102 and the subsequent steps are repeated. When search branches cannot be extended and search cannot be performed, the search process is completed.

### (D) Process of Creating Search Range Data

First Process of Creating Search Range Data

FIG. 10 is the flowchart of the first process of creating search range data according to the present invention.

In step 201, a list of boundary-exit links that exit from all level 3 meshes to corresponding adjacent meshes is first created with reference to link records of the level 3 meshes. Then, in step 202, a list of boundary-entrance links that enter the level 3 meshes from the corresponding adjacent meshes is created with reference to the link records of the level 3 meshes.

Then, the starting mesh number i is set to one in step 203, the destination mesh number k is set to one in step 204, the number j of a boundary-exit link in a starting mesh is set to one in step 205, and the number m of a boundary-entrance link in a destination mesh is set to one in step 206.

Then, in step 207, a route from a j-th boundary-exit link in an i-th starting mesh to an m-th boundary-entrance link in a k-th destination mesh is searched. In this case, when i=k, step 207 and the subsequent steps are not performed.

When the route search process is completed, in step 208, the route from the j-th boundary-exit link to the m-th boundary-entrance link is traced back, and bits corresponding to meshes on the route are set to “1”. Then, in step 209, it is determined whether routes to all boundary-entrance links in the k-th destination mesh have been searched. When routes to all boundary-entrance links in the k-th destination mesh have not been searched, the process proceeds to step 210 where m is incremented by one. Then, step 207 and the subsequent steps are repeated.

When it is determined in step 209 that routes to all boundary-entrance links in the k-th destination mesh have been searched, the process proceeds to step 211. In step 211, it is determined whether routes from all boundary-exit links in the i-th starting mesh have been searched. When routes from all boundary-exit links in the i-th starting mesh have not been searched, the process proceeds to step 212 where j is incremented by one. Then, step 206 and the subsequent steps are repeated. When it is determined in step 211 that routes from all boundary-exit links in the i-th starting mesh have been searched, creation of search range data corresponding to the combination of mesh numbers (i,k) is completed.

Then, in step 213, it is determined whether the aforementioned process has been completed for all destination meshes. When the aforementioned process has not been completed for all destination meshes, the process proceeds to step 214 where k is incremented by one. Then, step 205 and the subsequent steps are repeated. When it is determined in step 213 that the aforementioned process has been completed for all destination meshes, creation of search range data corresponding routes from the i-th starting mesh to all destination meshes is completed.

Then, in step 215, it is determined whether the aforementioned process has been completed for all starting meshes. When the aforementioned process has not been completed for all starting meshes, the process proceeds to step 216 where i is incremented by one. Then, step 204 and the subsequent steps are repeated. When it is determined in step 215 that the aforementioned process has been completed for all starting meshes, creation of all search range data is completed.

Second Process of Creating Search Range Data

FIG. 11 is the flowchart of the second process of creating search range data according to the present invention. In this process, it is assumed that a list of boundary-exit links and a list of boundary-entrance links in individual meshes have been created already.

The starting mesh number i is set to one in step 201, and the number j of a boundary-exit link in a starting mesh is set to one in step 302.

Then, in step 303, a route from a j-th boundary-exit link in an i-th starting mesh is searched for by the Dijkstra method until the search process cannot be performed, i.e., until search branches cannot be extended. After the search process is completed, the destination mesh number k is set to one in step 304, and the number m of a boundary-entrance link in a destination mesh is set to one in step 305.

Then, in step 306, the route from the j-th boundary-exit link in the i-th starting mesh to an m-th boundary-entrance link in a k-th destination mesh is traced back, and bits corresponding to meshes on the route are set to “1”. Then, in step 307, it is determined whether the process in step 306 has been completed for all boundary-entrance links in the k-th destination mesh. When the process in step 306 has not been completed for all boundary-entrance links in the k-th destination mesh, the process proceeds to step 308 where m is incremented by one. Then, step 306 and the subsequent steps are repeated.

When it is determined in step 307 that the process in step 306 has been completed for all boundary-entrance links in the k-th destination mesh, the process proceeds to step 309. In step 309, it is determined whether the aforementioned process has been completed for all destination meshes. When the aforementioned process has not been completed for all destination meshes, the process proceeds to step 310 where k is incremented by one. Then, step 305 and the subsequent steps are repeated.

When it is determined in step 309 that the aforementioned process has been completed for all destination meshes, creation of search range data corresponding routes from the j-th boundary-exit link in the i-th starting mesh to all boundary-entrance links in all destination meshes is completed. Then, in step 311, it is determined whether the aforementioned process has been completed for all boundary-exit links in the i-th starting mesh. When the aforementioned process has not been completed for all boundary-exit links in the i-th starting mesh, the process proceeds to step 312 where j is incremented by one. Then, step 303 and the subsequent steps are repeated.

When it is determined in step 311 that routes from all boundary-exit links in the i-th starting mesh have been searched for, creation of search range data corresponding to combinations of the mesh having the mesh number i and the other meshes is completed.

Then, in step 313, it is determined whether the aforementioned process has been completed for all starting meshes. When the aforementioned process has not been completed for all starting meshes, the process proceeds to step 314 where i is incremented by one. Then, step 302 and the subsequent steps are repeated. When it is determined in step 313 that the aforementioned process has been completed for all starting meshes, creation of all search range data is completed.

### (E) Navigation Apparatus

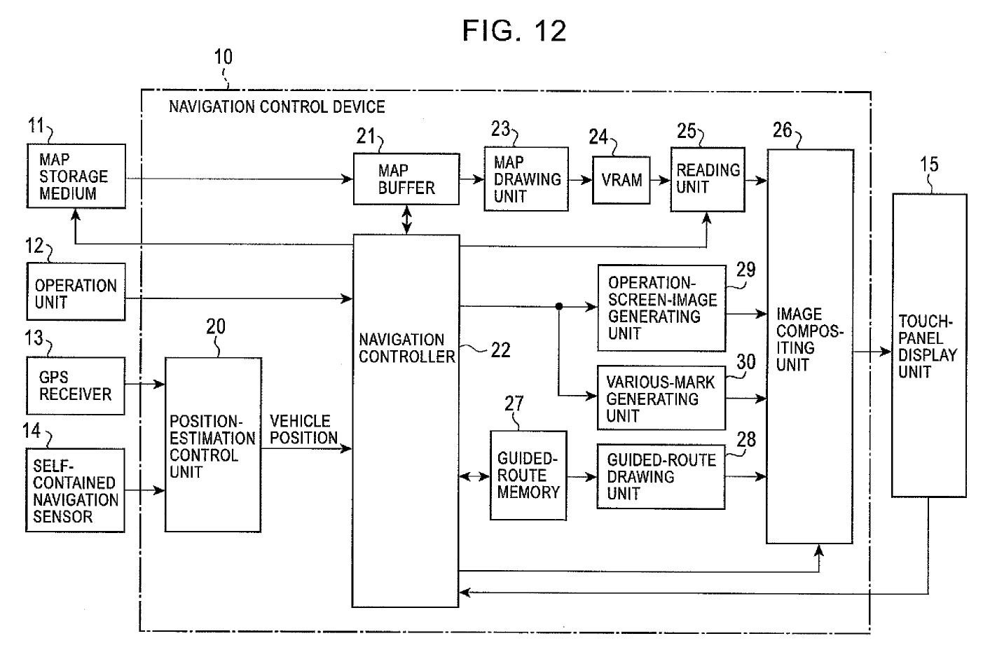

FIG. 12 is a block diagram of a navigation apparatus according to the present invention.

Map data created by the map creating apparatus shown in FIG. 6 is recorded on a map storage medium 11 (for example, a CD-ROM or a DVD). The map data is read from the map storage medium 11 as necessary. An operation unit 12 is used to operate a navigation control device 10 and includes a remote controller, hardkeys for operation, and the like. A global positioning system (GPS) receiver 13 receives GPS signals sent from a GPS satellite to calculate the current absolute location (a GPS location) and traveling direction of the vehicle. A self-contained navigation sensor 14 detects a change in the traveling direction and the distance traveled by the vehicle at predetermined intervals and inputs these items of data to the navigation control device 10.

A touch-panel display unit 15 displays a map around the current vehicle position, a guided route, a menu, a vehicle mark, and the like according to instructions from the navigation control device 10. The touch-panel display unit 15 inputs predetermined commands to the navigation control device 10 when softkeys displayed on the screen are pressed.

In the navigation control device 10, a position-estimation control unit 20 estimates the current vehicle position based on signals from the GPS receiver 13 and the self-contained navigation sensor 14 and inputs the estimated current vehicle position to a navigation controller 22. A map buffer 21 stores map data read from the map storage medium 11. The navigation controller 22 includes a map-read control unit that reads data of a map around the current vehicle position and outputs the data to the map buffer 21 according to various types of input information and command, a guided-route control unit that performs guided-route search control and route guidance control, an operation-screen-image-generation control unit that controls generation of various types of operation screen image and vehicle mark, and the like, which are not shown.

A map drawing unit 23 generates a map image using the read map data in the map buffer 21 and writes the map image to a video random access memory (VRAM) 24. An image reading unit 25 cuts out a predetermined part of the map image in the VRAM 24 and inputs the part of the map image to an image compositing unit 26 according to instructions from the navigation controller 22.

A guided-route memory 27 stores information of the guided route to the destination location that is searched by the guided-route control unit in the navigation controller 22, i.e., data of all links that constitute the guided route from the starting location to the destination location. A guided-route drawing unit 28 generates an image of the guided route using information on the guided route and inputs the generated image to the image compositing unit 26 to highlight the generated image on a drawn map. An operation-screen-image generating unit 29 generates various types of menu screen image (operation screen image) and inputs the various types of menu screen image to the image compositing unit 26. A various-mark generating unit 30 generates various types of mark, for example, a vehicle mark or a cursor, and inputs the various types of mark to the image compositing unit 26. The image compositing unit 26 superimposes the various types of mark, the image of the guided route, and the like on the map image read from the VRAM 24 and displays the resulting composite image on the entire area of the screen.

### (F) Guided-Route Search

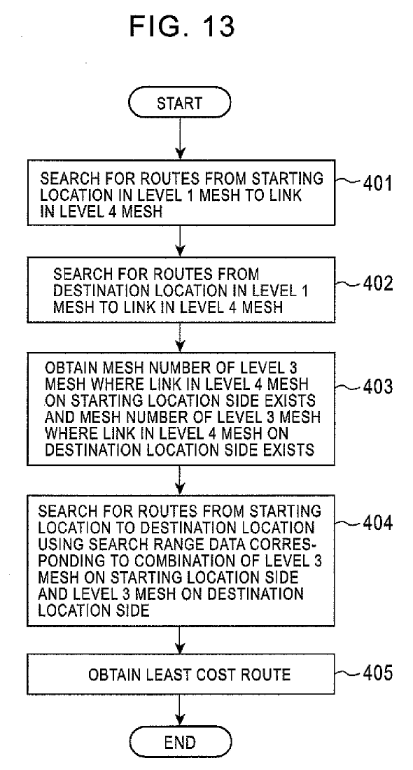

FIG. 13 is a flowchart of a process of searching for a guided route according to the present invention in a case where a starting location and a destination location are determined.

In step 401, routes from a starting location in a level 1 mesh to a link in a level 4 mesh are searched. Similarly, in step 402, routes from a destination location in a level 1 mesh to a link in a level 4 mesh are searched. Then, in step 403, the mesh numbers of individual level 3 meshes where the link in the level 4 mesh on the starting location side and the link in the level 4 mesh on the destination location side exist are obtained. A piece of search range data that is used when a route search is performed can be determined by the combination of the obtained level 3 mesh numbers.

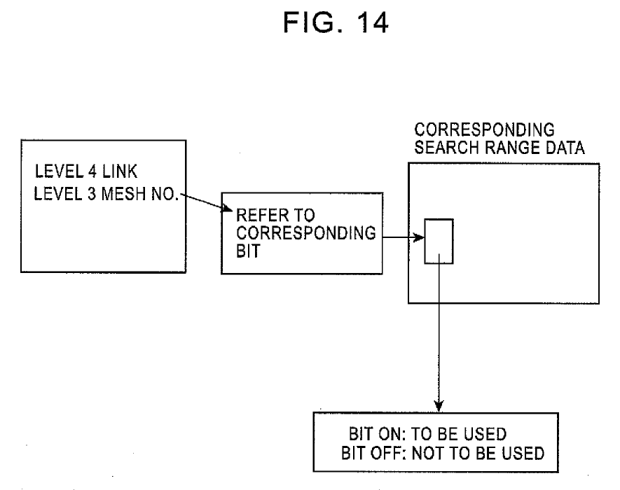

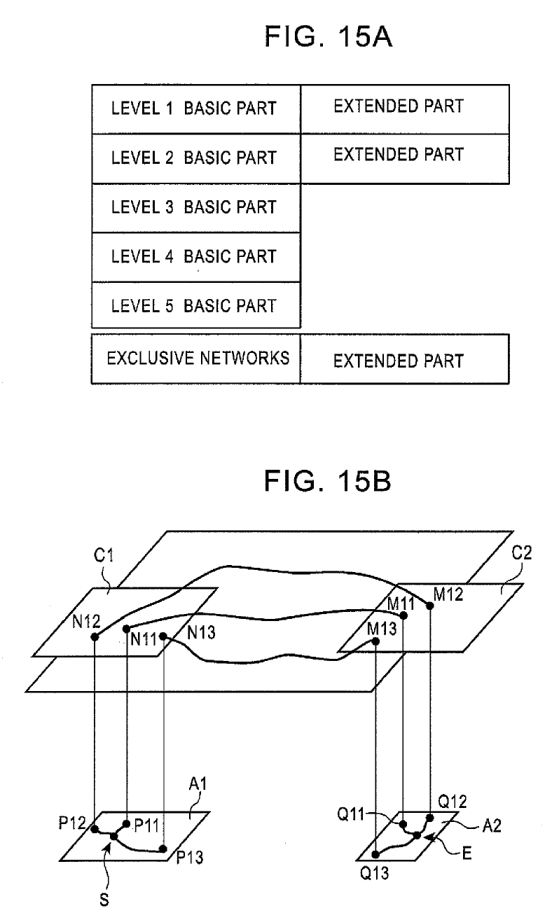

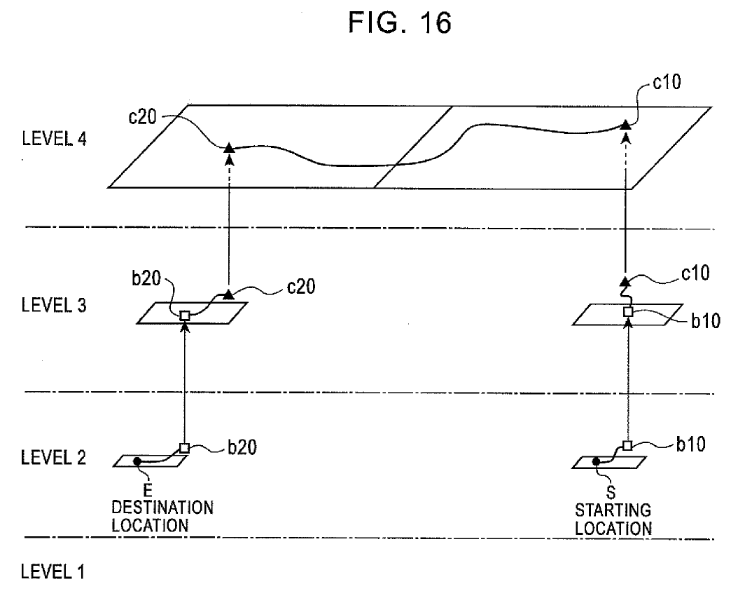

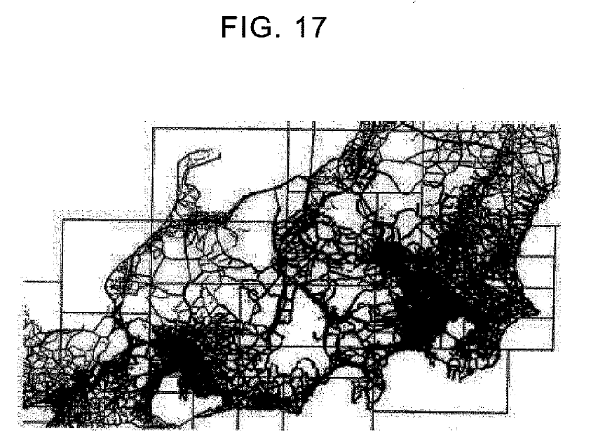

Then, in step 404, routes from the stating location to the destination location are searched using road information (link records) at level 4 with reference to the piece of search range data. That is to say, when a route search is performed, bits in the piece of search range data corresponding to level 3 mesh numbers included in link records of level 4 links are referred to (FIG. 14). When a certain one of the bits is set to “1” (on), a corresponding level 4 link is determined to be a link subject to a route search, and a route search is performed using the level 4 link. When a certain one of the bits is set to “0” (off), a corresponding level 4 link is determined not to be a link subject to a route search, and the level 4 link is not used when a route search is performed.

A plurality of routes from the starting location in the level 1 mesh to the link in the level 4 mesh are found in step 401. Thus, in step 405, for each of the plurality of routes, a route from the starting location to the destination location is searched, and the least cost route is obtained as a guided route.

In the present invention, in a hierarchical search, the search range can be narrowed down without affecting the quality level of a route, and thus, the search time can be reduced.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A method for creating map data for navigation comprising:
setting a plurality of levels corresponding to levels of detail,
stratifying meshes at the individual levels, and
creating map data that includes road information of the individual meshes at the individual levels, wherein the map data includes, for individual combinations of two meshes at a predetermined level, data for identifying meshes at the predetermined level that are used to search for routes from one mesh in each of the combinations of two meshes to the other mesh in each of the combinations of two meshes as search range data.

2. The method according to claim 1, comprising:
creating a list of boundary-exit links that exit from a mesh and a list of boundary-entrance links that enter a mesh for each of the meshes with reference to the road information of each of the meshes;
for individual combinations of two meshes, searching for all routes from boundary-exit links in one mesh in each of the combinations of two meshes to boundary-entrance links in the other mesh in each of the combinations of two meshes; and
creating the search range data from data for identifying meshes to which links that constitute each of the searched routes belong.

3. The method according to claim 1, comprising:
creating a list of boundary-exit links that exit from a mesh and a list of boundary-entrance links that enter a mesh for each of the meshes with reference to the road information of each of the meshes;
performing a search from boundary-exit links in a first mesh until the search cannot be performed and, after performing the search, obtaining all routes from the boundary-exit links in the first mesh to boundary-entrance links in a second mesh with reference to the search result; and
creating search range data corresponding to a combination of the first and second meshes by determining meshes to which links that constitute each of the searched routes belong.

4. The method according to claim 1, wherein the level of the meshes is a level immediately below a top level, a link that constitutes road information at the top level does not cross over meshes at the level immediately below the top level, and a link record of the link includes identification data of a mesh at the level immediately below the top level where the link exists.

5. A route search method for a navigation apparatus that searches for a route to a destination location, the method comprising:
setting a plurality of levels corresponding to levels of detail, stratifying meshes at the individual levels, storing, for individual combinations of two meshes at a level immediately below a top level, data for identifying meshes that are used to search for routes from one mesh in each of the combinations of two meshes to the other mesh in each of the combinations of two meshes as search range data, together with road information of the individual meshes at the individual levels, in map data, performing control so that a link that constitutes road information at the top level does not cross over meshes at the level immediately below the top level, and storing, in a link record of the link, identification data of a mesh at the level immediately below the top level where the link exists; and
searching for a route between nodes at the top level, using top-level links having mesh identification data of meshes that are defined to be used for route search in the search range data.

6. An apparatus for creating map data for navigation for setting a plurality of levels corresponding to levels of detail, stratifying meshes at the individual levels, and creating map data that includes road information of the individual meshes at the individual levels, the apparatus comprising:
a link-list creating unit that creates a list of boundary-exit links that exit from a mesh and a list of boundary-entrance links that enter a mesh for each of the meshes with reference to the road information of each of the meshes;
a route searching unit that, for individual combinations of two meshes, searches for all routes from boundary-exit links in one mesh in each of the combinations of two meshes to boundary-entrance links in the other mesh in each of the combinations of two meshes; and
a search-range-data creating unit that creates, from data for identifying meshes to which links that constitute each of the searched routes belong, search range data for identifying meshes that are used to search for routes from one mesh in each of the combinations of two meshes to the other mesh in each of the combinations of two meshes.

7. An apparatus for creating map data for navigation for setting a plurality of levels corresponding to levels of detail, stratifying meshes at the individual levels, and creating map data that includes road information of the individual meshes at the individual levels, the apparatus comprising:
a link-list creating unit that creates a list of boundary-exit links that exit from a mesh and a list of boundary-entrance links that enter a mesh for each of the meshes with reference to the road information of each of the meshes;
a route searching unit that performs a search from boundary-exit links in a first mesh until the search cannot be performed and, after performing the search, obtains all routes from the boundary-exit links in the first mesh to boundary-entrance links in a second mesh with reference to the search result; and
a search-range-data creating unit that creates, from data for identifying meshes to which links that constitute each of the searched routes belong, search range data for identifying meshes that are used to search for routes from the first mesh to the second mesh.

8. A navigation apparatus that searches for a route to a destination location, the navigation apparatus comprising:
a map-data storage unit that stores, for individual combinations of two meshes at a level immediately below a top level, data for identifying meshes that are used to search for routes from one mesh in each of the combinations of two meshes to the other mesh in each of the combinations of two meshes as search range data, together with road information of the individual meshes at individual levels, in map data, performs control so that a link that constitutes road information at the top level does not cross over meshes at the level immediately below the top level, and stores the map data, which includes, in a link record of the link, identification data of a mesh at the level immediately below the top level where the link exists;
a destination-location setting unit that sets a destination location; and
a route searching unit that obtains individual nodes at the top level on a starting location side and a destination location side and searches for a route between the nodes, using links at the top level having mesh numbers of meshes that are defined to be used for route search in the search range data.
